(19) United States
(12) Patent Application Publication
(10) Pub. No.: US 2014/0196537 A1
(43) Pub. Date: Jul. 17, 2014

(54) INTEGRATED MEASURING APPARATUS FOR MEASURING VAPOR PRESSURE AND LIQUID LEVEL OF LIQUID TANK

(71) Applicant: Kyong M. Park, Westlake Village, CA (US)

(72) Inventor: Kyong M. Park, Westlake Village, CA (US)

(73) Assignee: Auto Industrial Co., Ltd., Seoul (KR)

(21) Appl. No.: 13/740,638

(22) Filed: Jan. 14, 2013

(51) Int. Cl. G01F 23/14

(52) U.S. Cl. CPC G01F 23/14
USPC 73/299

(57) ABSTRACT

A technique for measuring vapor pressure and liquid level of a volatile liquid contained in a tank. An integrated measuring apparatus sequentially measures vapor pressure and differential pressure by use of a single pressure sensor and a switching valve which switches between paths for measurement of the vapor pressure and the differential pressure. In addition, the integrated measuring apparatus includes a pressure sensor configured to sequentially measure vapor pressure and total pressure or the combination of the vapor pressure and liquid pressure; and a switching valve configured to be connected to a vapor pressure tube and a liquid pressure tube and switch between connection paths with at least one input port of the pressure sensor, wherein the vapor pressure tube is connected to an upper part of the tank and the liquid pressure tube is connected to a lower part of the tank.

### BACKGROUND

1. Field

The following description relates to a measurement technique, and more particularly, to a technique for measuring vapor pressure and liquid level in a tank, such as an automobile fuel tank, which contains a volatile liquid.

2. Description of the Related Art

PCT Patent Publication No. 1990/008303 (published on Jul. 26, 1990) discloses a method for measuring the amount of liquid in a fuel tank by use of a differential pressure probe measuring a difference in pressure between an upper region and a lower region of the fuel tank. This method is advantageous in durability, as compared to a conventional floater-using measurement method, since it does not have an electrical contacting point. However the practical implementation of this method is not likely to be feasible because of the use of costly pressure sensor.

There is a method for preventing a vaporized gas from flowing into the interior of a vehicle or out to the outside by measuring vapor pressure of the gas and burning the vaporized gas in an engine combustor when the measured vapor pressure is equal to or greater than a threshold.

Both the above two methods utilize a pressure sensor. U.S. Pat. No. 6,006,596, which was allowed to Robert Bosch Gmbh on Dec. 28, 1999, discloses a method of incorporating the above-mentioned techniques using a single differential pressure sensor package capable of measuring two differential pressures. German Patent Publication No. DE4227893 discloses a configuration of such a pressure sensor. However, the above-described sensor with a double structure is expensive and due to the nature of structure, two input ports are arranged very closely to each other on the same surface of a sensor package. Thus, this arrangement causes s physical limitations and difficulties in sensor installation.

### SUMMARY

The following description relates to a low-cost integrated measuring apparatus for measuring liquid level and vapor pressure of a volatile liquid contained in a tank.

In addition, the following description relates to an integrated measuring apparatus capable of providing a high degree of freedom in design of a tank.

Further, the following description relates to an integrated measuring apparatus with an enhanced durability due to the absence of a mechanical driving unit.

In one general aspect, there is provided an integrated measuring apparatus sequentially measuring vapor pressure and differential pressure by use of a single pressure sensor and a switching valve which switches between paths for measurement of the vapor pressure and the differential pressure.

More specifically, the integrated measuring apparatus includes: a pressure sensor configured to sequentially measure vapor pressure and total pressure or the combination of the vapor pressure and liquid pressure; and a switching valve configured to be connected to a vapor pressure tube and a liquid pressure tube and switch between connection paths with at least one input port of the pressure sensor, wherein the vapor pressure tube is connected to an upper part of the tank and the liquid pressure tube is connected to a lower part of the tank.

In another general aspect, there is provided an integrated measuring apparatus for measuring liquid level and vapor pressure of a liquid contained in a tank, including: a pressure sensor configured to comprise a first input port connected to one end of a vapor (or vaporized gas) pressure tube having the other end connected to an upper part of the tank; and a switching valve configured to comprise a first inlet port connected to one end of a liquid pressure tube having the other end connected to a lower part of the tank and an outlet port connected to a second input port of the pressure sensor.

The integrated measuring apparatus may further include a controller configured to control the switching valve to output a vapor-pressure-indicating signal measured at the first input port of the pressure sensor in first switching state and a liquid-level-indicating signal generated from differential pressure measured in second switching state.

The integrated measuring apparatus may further include a controller configured to control the switching valve to output a vapor-pressure-indicating signal measured by the pressure sensor in first switching state and a liquid-level-indicating signal generated from liquid pressure which is a difference between a total pressure of the tank measured by the pressure sensor in the second switching state and the vapor pressure measured in the first switching state.

The pressure sensor may be mounted at a same or lower level of the lower part of the tank.

Other features and aspects will be apparent from the following detailed description, the drawings, and the claims.

### BRIEF DESCRIPTION OF THE DRAWINGS

FIG. 1 is a block diagram illustrating an integrated measuring apparatus according to an exemplary embodiment of the present invention.

FIG. 2 is a block diagram illustrating an integrated measuring apparatus according to another exemplary embodiment of the present invention.

FIG. 3 is a flowchart illustrating an integrated measuring method according to an exemplary embodiment of the present invention.

FIG. 4 is a flowchart illustrating an integrated measuring apparatus according to another exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

An integrated measuring apparatus may use a single pressure sensor to measure vaporized-gas pressure and differential pressure by means of a switching valve to switch between a path for measuring the vaporized-gas pressure and a path for measuring the differential pressure.

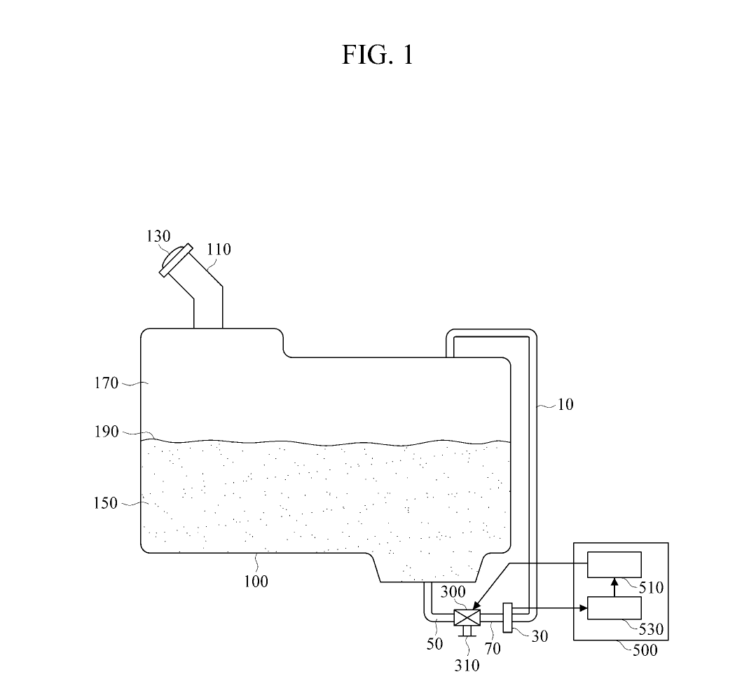

FIG. 1 is a block diagram illustrating an integrated measuring apparatus according to an exemplary embodiment of the present invention. Although FIG. 1 illustrates a fuel tank, the present invention may apply not only to the fuel tank but also to any integrated measuring apparatus that is able to be mounted on the fuel tank, as claimed in the accompanying claims, and may apply to an integrated measurement method using the integrated measuring apparatus.

The integrated measuring apparatus may include a tank 100, a pressure sensor 30, a vapor (or vaporized gas) pressure tube 10, a liquid pressure tube 50, and a switching valve 300. The pressure sensor 30 sequentially measures vapor pressure, total pressure, and liquid pressure in the tank 100. The vapor pressure tube 10 is connected to an upper part of the tank 100, and the liquid pressure tube 50 is connected to a lower part of the tank 100. The switching valve 300 switches communication paths, each of which is connected to at least one input port of the pressure sensor 30.

As shown in FIG. 1, the switching valve 300 has a first inlet port and an outlet port, wherein the first inlet port is connected to one end of the liquid pressure tube 50 and an outlet port is connected to a second input port of the pressure sensor 30 directly or via a connection tube 70. The pressure sensor 30 has a first input port connected to one end of the vapor pressure tube 10. For example, the switching valve 300 and the pressure sensor 30 may be provided independently of each other, and connected via the connection tube 70. For example, the switching valve 300 and the pressure sensor 30 may be integrated into one component.

The tank 100 may be, for example, an automobile fuel tank formed of metal. The tank 100 contains liquid fuel 150, such as gasoline, for a vehicle. The fuel may be volatile and a gas 170 vaporized from a liquid surface 190 of the fuel 150 fills an upper portion of the tank 100. The present invention may apply to a technique for measuring both vaporized-gas pressure and fuel level of the tank containing the volatile gas, and is not limited to automobile fuel tanks.

Vapor pressure described herein refers to a pressure of a vaporized gas above the liquid surface of the fuel in the tank, and liquid pressure described herein refers to a pressure exerted by weight of a liquid, such as gasoline, under the liquid surface inside the tank. In addition, total pressure described herein refers to a pressure exerted on a bottom of the tank 100, which is a sum of the vapor pressure and the liquid pressure. A liquid level of the tank may be measured based on the liquid pressure which is in proportion to the weight of the liquid.

The vapor pressure tube 10 has one end connected to an upper part of the tank 100. In the “upper part”, the vapor pressure of the tank is capable of being measured, and as shown in drawings, the upper part may be desirably, but not necessarily, high enough for the liquid surface to be unable to touch even when the liquid surface in the tank full with the fuel is waved by the vehicle's vibration during driving. However, the touching of the liquid to the upper part does not make it impossible to measure the vapor pressure. For example, the vapor pressure tube 10 may have one end communicating with the upper part of the tank via an opening on a top surface of the tank and the other end connected to a vapor pressure chamber that is independently provided at a bottom of the tank to prevent the liquid from flowing in.

The liquid pressure tube 50 has an end connected to the lower part of the tank 100. The “lower part” is a place where the liquid fuel is still left in the tank even when the fuel is almost used up. In another example, the pressure sensor 30 may be mounted at the same or lower level of the lower part of the tank 100. The “same or lower level of the lower part of the tank” indicates a level below or similar to the level of the lower part of the tank, at which the fuel fills the tube between the lower part of the tank and the pressure sensor and thereby no air can be drawn into the tube. The liquid pressure tube 50 may be always filled with a liquid, and, in the exemplary embodiment, with fuel. The fully filled liquid pressure tube 50 may expedite a pressure-measurement response time.

In one embodiment, the pressure sensor 30 is a differential pressure sensor. The switching valve 300 may be, for example, a three-port valve operated by a solenoid, and switches between a first inlet port and a second inlet port 310 to selectively communicate with an outlet port in response to an electrical signal. Reference pressure, for example, atmospheric pressure, may be applied to the second inlet port 310 of the switching valve 300.

In another example, the integrated measuring apparatus may further include a controller 500 to control the switching valve 300 to output a vapor-pressure-indicating signal measured in first switching state and a liquid-level-indicating signal generated from differential pressure measured in second switching state.

In another embodiment, the integrated measuring apparatus may further include a controller 500 to control the switching valve such that the second inlet port communicates with the outlet port in the first switching state and the first inlet port communicates with the outlet port in the second switching state.

In the embodiment shown in drawings, the controller 500 controls the switching valve to control the switching valve 300 to output the vapor-pressure-indicating signal measured in the first switching state and the liquid-level-indicating signal generated from differential pressure measured in the second switching state.

In yet another example, the controller 500 periodically measures vaporized-gas pressure and liquid level alternately. A pressure measurement unit of the controller 500 reads in a pressure value from the input sensor 30 and outputs it to an external device. The pressure measurement unit 530 may consist of an integrator, an amplifier, and an analog-to-digital converter (ADC), wherein the integrator integrates analog-electrical signals output from the pressure sensor 30 for a predefined period of time, the amplifier amplifies an output of the integrator to an appropriate signal level and the ADC converts the amplified analog signal into a digital signal. In another example, the pressure measurement unit 530 may consist of only an amplifier to amplify an analog electrical signal output from the pressure sensor 30. The pressure measurement unit 530 is not limited to the above configuration, and may be implemented in various ways depending on technical specifications defined by a vehicle manufacturer that employs the integrated measuring apparatus according to the exemplary embodiments.

The pressure measurement unit 530 may be configured to include individual circuits to measure vapor pressure and liquid pressure independently, or be implemented as a single component having different outputs. For example, in the vapor pressure measurement, a vapor-pressure-indicating signal output from the pressure measurement unit 530 may be input to a control circuit that drives a valve on a recycling path along which the vaporized gas is recycled to an engine cylinder room. In this case, the pressure measurement unit 530 may compare the measured vapor pressure with a predefined reference value, and, if the measured vapor pressure is equal to or greater than the reference value, output the vapor-pressure-indicating signal to the control circuit for notification.

A valve operating unit 510 operates the switching valve 300 in response to an instruction from the pressure measurement unit 530. The valve operating unit 510 may be a circuit to generate and output a direct current or pulse signal for driving, for example, a solenoid valve.

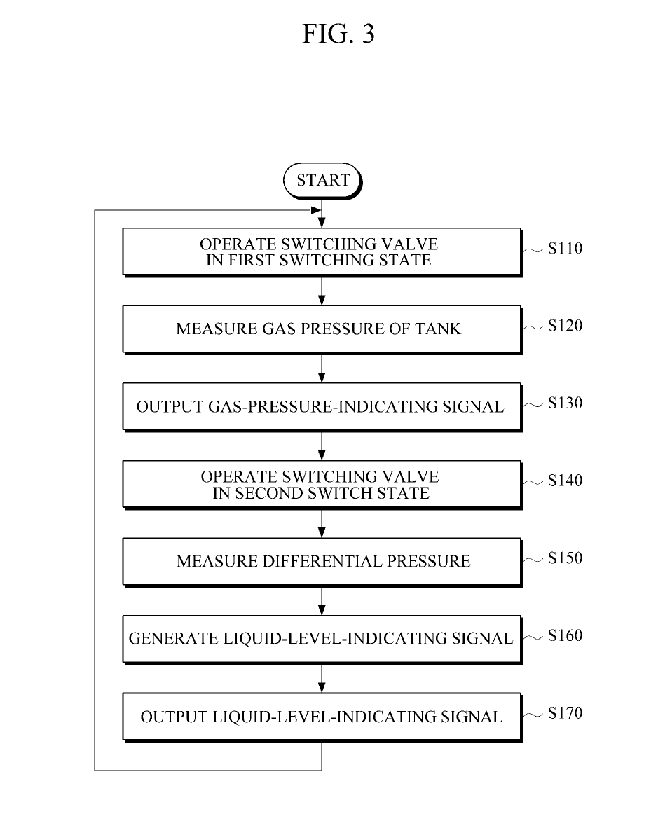

FIG. 3 is a flowchart illustrating an integrated measuring method according to an exemplary embodiment of the present invention. Referring to FIG. 3 in conjunction with FIG. 1, the valve operating unit 510 of the controller 500 operates the switching valve 300 to set a communication path of the switching valve 300 to first switching state in operation S110. In this example, the switching valve 300 blocks the first inlet port of the switching valve 300 and allows the second inlet port to communicate with the outlet port. Accordingly, vapor pressure is applied to the first input port of the pressure sensor 30, as a differential pressure sensor, via the vapor pressure tube 10, and atmospheric pressure is applied to the second input port from the second inlet port of the switching valve 300.

Thereafter, the pressure measurement unit 530 of the controller 500 reads in a measurement value of the differential pressure sensor and generates a vapor-pressure-indicating signal which is an electrical signal related to the vapor pressure on the liquid surface in operation S120. Then, the generated vapor-pressure-indicating signal is output in operation S130. The vapor-pressure-indicating signal may be generated by processing an electrical signal output from the pressure sensor, wherein the electrical signal is integrated for a predefined period of time, the resulting integrated electrical signal is amplified to an appropriate signal level and then converted into a digital signal. In another example, the vapor-pressure-indicating signal may be an analog signal which is obtained by simply amplifying an electrical signal output from the pressure sensor. In yet another example, the vapor-pressure-indicating signal may be a pulse train signal or an analog level signal that indicates that vapor pressure value is greater than a reference value.

Thereafter, the valve operating unit 510 operates the switching valve to set the communication path to second switching state in operation S140. In one embodiment, the switching valve 300 blocks the second inlet port and allows the first inlet port to communicate with the outlet port. Consequently, the vapor pressure is applied to the first input port of the pressure sensor 30, as a differential pressure sensor via the vapor pressure tube 10 and the total pressure at the first inlet port of the switching valve 300 is applied to the second input port, wherein the total pressure is a sum of liquid pressure exerted by the liquid fuel contained in the tank 100 and the vapor pressure of the vaporized gas above the liquid surface of the fuel.

Then, the pressure measurement unit 530 of the controller 500 reads in the measurement value from the differential pressure sensor to measure the liquid pressure of the fuel contained in the tank, and generates a liquid-level-indicating signal that is an electrical signal related to the measured liquid pressure in operation S160. Thereafter, the pressure measurement unit 530 outputs the liquid-level-indicating signal in operation S170. The liquid pressure obtained by subtracting the vapor pressure on the liquid surface of the fuel from the total pressure is in proportion to the liquid level of the fuel in the tank.

The vapor-pressure-indicating signal and the liquid-level indicating signal may be concurrently output through different output ports. Alternatively, they may be output from different components connected to an external device at a predefined time point which is specified according to technical specifications. For example, the vapor-pressure-indicating signal may be input to the control circuit which drives a valve on a recycling path along which the vaporized gas is recycled to the engine cylinder room. In another example, only when the comparison result from the pressure measurement unit 530 indicates that the measured vapor pressure is equal to or greater than a predefined reference value, the vapor-pressure-indicating signal is output to the control circuit.

The liquid-level-indicating signal may be output to a display control circuit that displays the liquid level of the fuel in the tank. In this case, the liquid-level-indicating signal may be output as an average value acquired for a predefined period of time, so as to avoid the effects of the vehicle's vibration. In another example, both the vapor-pressure-indicating signal and the liquid-level-indicating signal may be output through a single port of a network in the vehicle, for example, Car Area Network (CAN).

In the exemplary embodiment shown in FIG. 1, the positions of the switching valve 300 and the pressure sensor 30 may be inverted. Although not illustrated, in the modified embodiment, the first inlet port of the switching valve 300 may be connected to one end of the vapor pressure tube 10 and the outlet port may be connected to the second input port of the pressure sensor 30 directly or via the connection tube 70. Also, the first input port of the pressure sensor 30 may be connected to one end of the liquid pressure tube and atmospheric pressure may be applied to the second input port of the pressure sensor 30. The technical structure of operation of the modified embodiment may be similar to those of the exemplary embodiment illustrated in FIG. 1.

In addition, in the modified embodiment, the installation level of the pressure sensor 30 may be mounted at the same or lower level of the lower part of the tank. The term “same or lower level of the lower part of the tank” indicates a level below or similar to the level of the lower part of the tank, at which the fuel fully fills the tube between the lower part of the tank and the pressure sensor and thereby no air can be drawn into the tube. The switching valve 300 may be, for example, a three-port valve that is operated by a solenoid, and allow one of two inlet ports to selectively communicate with an outlet port in response to an electrical signal. Reference pressure, for example, atmospheric pressure, may be applied to the second inlet port 310 of the switching valve 300.

In the modified embodiment, the integrated measuring apparatus may further comprise a controller 500 to control the switching valve 300 to output a vapor-pressure-indicating signal measured in first switching state and a liquid-level-indicating signal generated from differential pressure measured in second switching state. Detailed configuration and operation of the controller 500 are similar to those of the controller illustrated in FIG. 1.

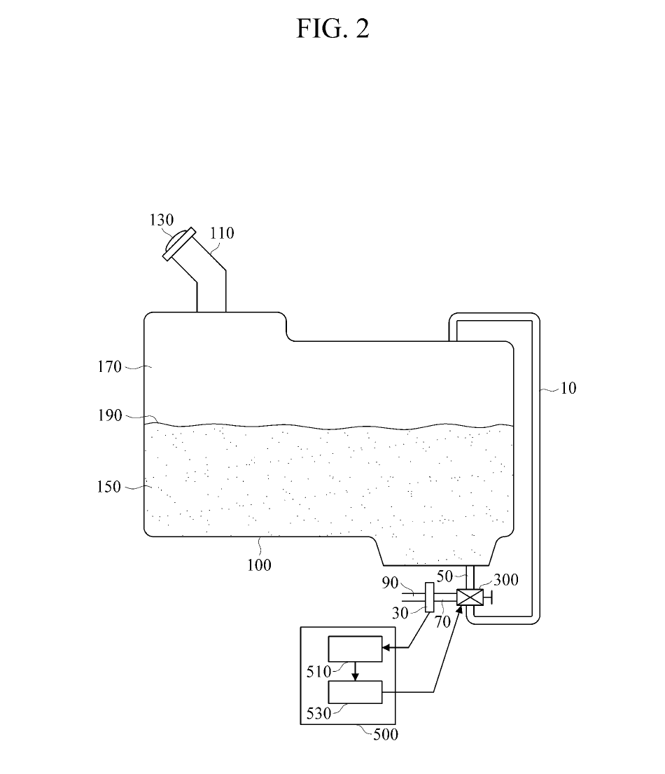

FIG. 2 is a block diagram illustrating an integrated measuring apparatus according to another exemplary embodiment of the present invention. As shown in FIG. 2, the integrated measuring apparatus includes a switching valve 300 and a pressure sensor 30. The switching valve 300 includes a first inlet port connected to one end of a vapor pressure tube 10 having the other end connected to an upper part of a tank 100 and a second inlet port connected to one end of a liquid pressure tube 50 connected to a lower part of the tank 100. The pressure sensor 30 includes a first input port connected to an outlet port of the switching valve 300 and a second input port to which atmospheric pressure is applied.

In this example, the switching valve 300 and the pressure sensor 30 may be provided as individual components and be connected via a connection tube 70. In another example, the switching valve 300 and the pressure sensor 30 may be integrated into one component.

The tank 100 may be, for example, an automobile fuel tank, and formed of metal. The tank 100 contains liquid fuel 150, such as gasoline, of a vehicle. As the fuel 150 is volatile, a gas 170 vaporized from a liquid surface 160 of the fuel 150 fills an upper portion of the tank 100. The present invention may apply to a technique for measuring both vaporized-gas pressure and fuel level of the tank containing the volatile gas, and the present invention is not limited to automobile fuel tanks.

The vapor pressure tube 10 has an end connected to the upper part of the tank 100. In the “upper part”, the vapor pressure of the tank is capable of being measured, and as shown in drawings, the upper part may be desirably, but not necessarily, high enough for the liquid surface to be unable to touch even when the liquid surface in the tank full with the fuel is waved by the vehicle's vibration during driving. However, the touching of the liquid to the upper part does not make it impossible to measure the vapor pressure. For example, the vapor pressure tube 10 may have one end communicating with the upper part of the tank via an opening on a top surface of the tank and the other end connected to a vapor pressure chamber that is independently provided at a bottom of the tank to prevent the liquid from flowing in.

The liquid pressure tube 50 has an end connected to the lower part of the tank 100. The “lower part” is a place where the liquid fuel is still left in the tank even when the fuel is almost used up. In another example, the pressure sensor 30 may be mounted at the same or lower level of the lower part of the tank 100. The “same or lower level of the lower part of the tank” indicates a level below or similar to the level of the lower part of the tank, at which the fuel fills the tube between the lower part of the tank and the pressure sensor and thereby no air can be drawn into the tube. The liquid pressure tube 50 may be always filled with a liquid, and, in the exemplary embodiment, with fuel. The fully filled liquid pressure tube 50 may expedite a pressure-measurement response time.

In one embodiment, the pressure sensor 30 is a gauge pressure sensor. The switching valve 300 may be, for example, a three-port valve that is operated by a solenoid, and allow one of two inlet ports to selectively communicate with an outlet port in response to an electrical signal.

As shown in FIG. 2, the first inlet port of the switching valve 300 is connected to one end of the vapor pressure tube 10 having the other end connected to the upper part of the tank, and the second inlet port is connected to one end of the liquid pressure tube 50 having the other end connected to the lower part of the tank 100. The first input port of the pressure sensor 30 is connected to the outlet port of the switching valve 300 and atmospheric pressure is applied to the second input port of the switching valve 300. The gauge pressure sensor is to measure pressure relative to atmospheric pressure. Thus, the second input port may not be actually provided in the gauge pressure sensor, and the pressure sensor 30 may be configured to form atmospheric pressure inside. However, the present invention is not limited to the above configuration, and in the embodiment illustrated in FIG. 2, the pressure sensor 30 may be a differential pressure sensor that is mounted for exposure to atmospheric pressure.

In another example, the integrated measuring apparatus may further include a controller 500 to control the switching valve 300 such that the first inlet port of the switching valve 300 can communicate with the outlet port in first switching state and the second inlet port can communicate with the outlet port in second switching state.

In yet another example, the controller 500 may control the switching valve 300 to output a vapor-pressure-indicating signal measured in the first switching state and a liquid-level-indicating signal generated from differential pressure measured in the second switching state.

In this example, the controller 500 periodically measures vaporized-gas pressure and liquid level alternately. A pressure measurement unit 530 of the controller 500 reads in a pressure value measured by the pressure sensor 30 and outputs it to an external device. In one embodiment, the pressure measurement unit 530 may consist of an integrator, an amplifier, and an analog-to-digital converter (ADC), wherein the integrator integrates analog-electrical signals output from the pressure sensor 30 for a predefined period of time, the amplifier amplifies an output from the integrator to an appropriate signal level and the ADC converts the amplified analog signal into a digital signal. In another example, the pressure measurement unit 530 may consist of only an amplifier to amplify an analog electrical signal output from the pressure sensor 30. The pressure measurement unit 530 is not limited to the above configuration, and may be implemented in various ways depending on technical specifications defined by a vehicle manufacturer that employs the integrated measuring apparatus according to the exemplary embodiments.

In addition, the pressure measurement unit 530 may be configured to include individual circuits to measure vapor pressure and liquid pressure independently, or be implemented as a single component having different outputs. For example, in the vapor pressure measurement, a vapor-pressure-indicating signal output from the pressure measurement unit 530 may be input to a control circuit that drives a valve on a recycling path along which the vaporized gas is recycled to an engine cylinder room. In this case, the pressure measurement unit 530 may compare the measured vapor pressure with a predefined reference value, and, if the measured vapor pressure is equal to or greater than the reference value, output the vapor-pressure-indicating signal to the control circuit for notification.

The valve operating unit 510 operates the switching valve 300 in response to an instruction from the pressure measurement unit 530. The valve operating unit 510 may be a circuit that generates and outputs a direct current or pulse signal for driving a solenoid valve.

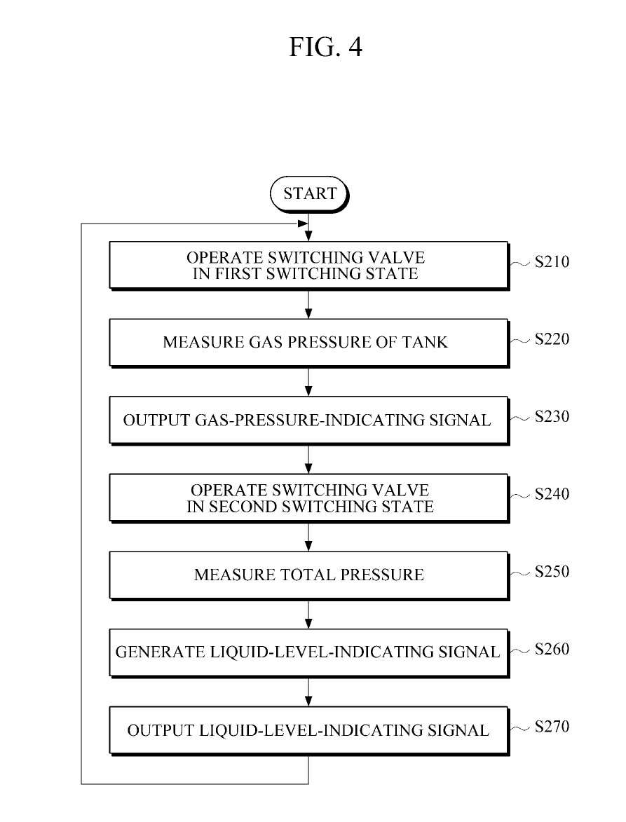

FIG. 4 is a flowchart illustrating an integrated measuring apparatus according to another exemplary embodiment of the present invention. Referring to FIG. 4 in conjunction with FIG. 2, the valve operating unit 510 of the controller 500 operates the switching valve 300 to set a communication path of the switching valve 300 to first switching state in operation S210. The switching valve 300 may block the first inlet port and allow the second inlet port to communicate with the outlet port. As a result, vapor pressure may be applied to the first input port of the pressure sensor 30 via the vapor pressure tube 10, and since the pressure sensor 30 is a gauge pressure sensor, the pressure sensor 30 measures the vapor pressure in relative to atmospheric pressure. However, the pressure sensor 30 may be a differential pressure sensor having the second inlet port to which atmospheric pressure is applied. In the exemplary embodiments of the present invention, the gauge sensor and the differential pressure sensor having the second input port to which atmospheric pressure is applied are considered as being equal in configurations.

Then, the pressure measurement unit 530 of the controller 500 reads in a measurement value of the pressure sensor and generates a vapor-pressure-indicating signal that is an electrical signal related to the vapor pressure on the liquid surface of the fuel in operation S220. Then, the pressure measurement unit 530 outputs the generated vapor-pressure-indicating signal in operation S230. The vapor-pressure-indicating signal may be generated by processing an electrical signal output from the pressure sensor, wherein the electrical signal is integrated for a predefined period of time, the resulting integrated electrical signal is amplified to an appropriate signal level and then converted into a digital signal. In another example, the vapor-pressure-indicating signal may be an analog signal which is obtained by simply amplifying an electrical signal output from the pressure sensor. In yet another example, the vapor-pressure-indicating signal may be a pulse train signal or an analog level signal that indicates that a vapor pressure value is greater than a reference value.

Thereafter, the valve operating unit operates the switching valve to set the connection path of the switching valve to the second switching state in response to an instruction from the pressure measurement unit 530 in operation S240. The switching valve 300 blocks the second inlet port and allows the first inlet port to communicate with the outlet port. Accordingly, a total pressure at the first inlet port of the switching valve 300 is applied to the first input port of the pressure sensor 30, as a gauge pressure sensor, wherein the total pressure is a sum of liquid pressure of the fuel 150 contained in the tank 100 and the vapor pressure of a vaporized gas at the liquid surface 190 of the fuel 150.

Then, the pressure measurement unit 530 reads in the measurement value of the pressure sensor 30 to measure the total pressure of the tank with reference to atmospheric pressure in operation S250. Then, the pressure measurement unit 530 calculates liquid pressure by subtracting the vapor pressure measured in operation S220 from the measured total pressure and generates a liquid-level-indicating signal which is an electrical signal obtained from the liquid pressure in operation S260. The generated liquid-level-indicating signal is output in operation S270. The liquid pressure obtained by subtracting the vapor pressure on the liquid surface of the fuel from the total pressure is in proportion to the liquid level of the fuel in the tank.

The vapor-pressure-indicating signal and the liquid-level-indicating signal may be simultaneously output through different output ports. Alternatively, they may be output through different components connected to an external device at a predefined time point which is specified according to technical specifications. For example, the vapor-pressure-indicating signal may be input to the control circuit which drives a valve on a recycling path along which the vaporized gas is recycled to an engine cylinder room. In another example, only when the comparison result from the pressure measurement unit 530 indicates that the measured vapor pressure is equal to or greater than a predefined reference value, the vapor-pressure-indicating signal is output to the control circuit.

The liquid-level-indicating signal may be output to a display control circuit that displays the liquid level of the fuel in the tank. In this case, the liquid-level-indicating signal may be output as an average value acquired for a predefined period of time, so as to avoid the effects of the vehicle's vibration. In another example, both the vapor-pressure-indicating signal and the liquid-level-indicating signal may be output through a single port of a network in the vehicle, for example, Car Area Network (CAN).

A switching valve, for example, a solenoid vale is much cheaper than a precise pressure sensor. Thus, an integrated measuring apparatus including one solenoid valve and one precise pressure sensor is far more inexpensive than an integrated measuring apparatus including one vapor-pressure-measuring device and two liquid-level-measuring devices, each including one differential pressure sensor. In addition, the integrated measuring apparatus including the single solenoid valve and the single precise pressure sensor is more advantageous in terms of fabrication cost, when compared to a specialized pressure sensor in which two differential pressure sensors are integrated into one package.

Further, the solenoid valve is a wide-use component used for various parts of a vehicle, and its durability has been proven over many years of use.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An integrated measuring apparatus for measuring liquid level and vapor pressure of a liquid contained in a tank, comprising:
a pressure sensor configured to comprise a first input port connected to one end of a vapor (or vaporized gas) pressure tube having the other end connected to an upper part of the tank; and
a switching valve configured to comprise a first inlet port connected to one end of a liquid pressure tube having the other end connected to a lower part of the tank and an outlet port connected to a second input port of the pressure sensor.

2. The integrated measuring apparatus of claim 1, further comprising:
a controller configured to control the switching valve to output a vapor-pressure-indicating signal measured at the first input port of the pressure sensor in first switching state and a liquid-level-indicating signal generated from a difference in pressure between the first and second input ports of the pressure sensor in second switching state.

3. The integrated measuring apparatus of claim 2, wherein the switching valve is configured to further comprise a second inlet port to which atmospheric pressure is applied, and the controller is configured to control the switching valve such that the second inlet port communicates with the outlet port in first switching state and the first inlet port communicates with the outlet port in second switching state.

4. The integrated measuring apparatus of claim 1, wherein the pressure sensor is mounted at a same or lower level of the lower part of the tank.

5. An integrated measuring apparatus for measuring liquid level and vapor pressure of a liquid contained in a tank, comprising:
a switching valve configured to comprise a first inlet port connected to one end of a vapor (or vaporized gas) pressure tube having the other end connected to an upper part of the tank; and
a pressure sensor configured to comprise a first input port connected to an outlet port of the switching valve and a second input port connected to one end of a liquid pressure tube having the other end connected to a lower part of the tank.

6. An integrated measuring apparatus for measuring liquid level and vapor pressure of a liquid contained in a tank, comprising:
a switching valve configured to comprise a first inlet port connected to one end of a vapor pressure tube having the other end connected to an upper part of the tank and a second inlet port connected to one end of a liquid pressure tube having the other end connected to a lower part of the tank; and
a pressure sensor configured to comprise a first input port connected to an outlet port of the switching valve and a second input port to which atmospheric pressure is applied.

7. The integrated measuring apparatus of claim 6, further comprising:
a controller configured to control the switching valve to output a vapor-pressure-indicating signal measured by the pressure sensor in first switching state and a liquid-level-indicating signal generated from liquid pressure which is a difference between a total pressure of the tank measured by the pressure sensor in second switching state and the vapor pressure measured in the first switching state.

8. The integrated measuring apparatus of claim 7, wherein the controller is configured to control the switching valve such that the first inlet port communicates with the outlet port in the first switching state and the second inlet port communicates with the outlet port in the second switching state.

9. A liquid tank comprising:
a tank configured to contain a liquid;
vapor (or vaporized gas) pressure tube configured to comprise one end connected to an upper part of the tank;
a liquid pressure tube configured to comprise one end connected to a lower part of the tank;
a pressure sensor configured to sequentially measure vapor pressure and total pressure, or a combination of vapor pressure and liquid pressure; and
a switching valve configured to switch communication paths between the vapor (or vaporized gas) pressure tube or the liquid pressure tube and at least one of first and second input ports of the pressure sensor.

10. The liquid tank of claim 9, wherein the vapor (or vaporized gas) pressure tube is configured to comprise the other end connected to the first input port of the pressure sensor, and the liquid pressure tube is configured to comprise the other end connected to a first inlet port of the switching valve having an outlet port connected to the second input port of the pressure sensor.

11. The liquid tank of claim 9, wherein the vapor (or vaporized gas) pressure tube is configured to comprise the other end connected to a first inlet port of the switching valve and the liquid pressure tube is configured to comprise the other end connected to the second input port of the pressure sensor having the first input port connected to an outlet port of the switching valve.

12. The liquid tank of claim 10, as an integrated measuring apparatus, further comprising:
a controller configured to control the switching valve to output a vapor-pressure-indicating signal measured at the first input port of the pressure sensor in first switching state and a liquid-level-indicating signal generated from a difference in pressure between the first and second input ports of the pressure sensor.

13. The liquid tank of claim 12, wherein the switching valve is configured to further comprise a second inlet port to which atmospheric pressure is applied and the controller is configured to control the switching valve such that the second inlet port communicates with an outlet port of the switching valve in the first switching state and the first inlet port communicates with the outlet port in the second switching state.

14. The liquid tank of claim 9, wherein the vapor (or vaporized gas) pressure tube is configured to further comprise the other end connected to a first inlet port of the switching valve, the liquid pressure tube is configured to further comprise the other end connected to a second inlet port of the switching valve, the first input port of the pressure sensor is connected to an outlet port of the switching valve, and atmospheric pressure is applied to the second input port of the pressure sensor.

15. The liquid tank of claim 9, as an integrated measuring apparatus, further comprising:
a controller configured to control the switching valve to output a vapor-pressure-indicating signal measured by the pressure sensor in first switching state and a liquid-level-indicating signal generated from a liquid pressure which is a difference between a total pressure of the tank measured by the pressure sensor in second switching state and the vapor pressure measured in the first switching state.

16. The liquid tank of claim 15, wherein the controller is configured to control the switching valve such that the first inlet port communicates with the outlet port in the first switching state and the second inlet port communicates with the outlet port in the second switching state.

17. The liquid tank of claim 9, wherein the pressure sensor is mounted at a same or lower level of the lower part of the tank.

18. An integrated measuring method for measuring liquid level and vapor pressure of a liquid contained in a tank, using an integrated measuring apparatus comprising one pressure sensor and a switching valve to switch a path at an input port of the pressure sensor, the method comprising:
measuring vapor pressure at a top surface of a liquid in a tank by controlling a path of the switching valve;
outputting a vapor-pressure-indicating signal;
measuring a differential pressure by controlling the path of the switching valve, wherein the differential pressure is a difference between the vapor pressure and a total pressure at a lower surface of the tank; and
generating a liquid-level-indicating signal from the differential pressure and outputting the generated signal.

19. An integrated measuring method for measuring liquid level and vapor pressure of a liquid contained in a tank, using an integrated measuring apparatus comprising one pressure sensor and a switching valve to switch a path at an input port of the pressure sensor, the method comprising:
measuring liquid pressure at a top surface of a liquid in a tank by controlling a path of the switching valve;
outputting a vapor-pressure-indicating signal;
measuring a total pressure at a lower surface of the tank by controlling the path of the switching valve; and
generating a liquid-level-indicating signal from a difference between the vapor pressure and the total pressure and outputting the signal.
